(19) United States
(12) Patent Application Publication
(10) Pub. No.: US 2012/0040813 A1
(43) Pub. Date: Feb. 16, 2012

(54) Containers and Method and Apparatus for Forming Containers

(75) Inventor: Leonard Reiffel, Chicago, IL (US)

(73) Assignee: Iron Mount Corporation, Madisonville, LA (US)

(21) Appl. No.: 12/083,447

(22) PCT Filed: Oct. 11, 2006
(86) PCT No.: PCT/US06/39969

§ 371 Date: Apr. 12, 2008

Related U.S. Application Data
(60) Provisional application No. 60/725,716, filed on Oct. 11, 2005.

(51) Int. Cl. B31B 1/00

(52) U.S. Cl. 493/52

(57) ABSTRACT

A metallurgical process involves providing an ingredient enclosure and placing a plurality of granules of a first material in the ingredient enclosure. The enclosure is formed using a blank (40) where a deformation former (28) deforms the blank against an aperture (24) in a plate (FIG. 1). No die blank is required on the opposite side of the blank from the deformation former. The first material is added into the formed container component. In one form, two approximately symmetrical hemispherical container components are attached together to form the enclosure. A metallurgical process furnace having a chamber in which ingredients for the metallurgical process are added is provided and the ingredient enclosure and the first material are added to the chamber. The chamber is heated after the addition of the ingredient enclosure and the first material to the chamber, although it may also be heated prior to such addition.

This Patent Application claims priority to U.S. provisional application No. 60,725,716, filed on Oct. 11, 2005 (which is incorporated herein by reference) and also concerns concepts found in my earlier U.S. Provisional Application Nos. 60/578,956 (filed 12 Jun. 2004), 60/604,364 (filed 24 Aug. 2004), 60/628,599 (filed 17 Nov. 2004), 60/633,614 (filed 6 Dec. 2004), which are all incorporated herein by reference as is my Formal Patent Application PCT/US05/020832 filed 12 Jun. 2005.

### BACKGROUND

One of the inventions disclosed herein relates to the field of apparatus and methods for forming containers and container components, and more specifically, to apparatus and methods for forming low cost container components.

The processing of iron and steel generates huge amounts of waste material consisting of small particles of iron oxide and other so-called “fines” and scrap—the former being typified by oxide-rich sand-like grains and brittle pieces of both larger and smaller size. Many techniques have been applied to the difficult challenge of economically recycling such materials. Generally these recovery and recycling methods require crushing the waste to relatively small size, mixing the ferrous material with various chemicals that may include fluxes and carbon-containing reducing agents such as ground coke, adding water and binding compounds such as cement, pelletizing the mixture, aging and drying the so-called green pellets, and, in the particular process known as hot briquetting, the exposing the pellets to high temperatures to convert the oxides. A major reason for such procedures is the high velocity gas flows that the material encounters during down-stream recycling operations (such as those carried out in blast furnaces and other apparatus for smelting and steel-making) produce extremely serious dust problems if the fine material were not transformed into the hard and mechanically resistant pellets or similar forms.

A key characteristic of mill scale is that it is a largely comprised of small particles “fines” rich in iron oxide. If simply dropped into the furnace these “fines” are often entrained by the high velocity air blast permeating the blast furnace and quickly ejected from the system. A portion of those fines that are not ejected can seriously clog and impede the passage of blast gases upward through the furnace thus reducing its efficiency. These problems have led to the various very expensive and energy-consuming processes now used to re-cycle limited amounts of mill scale. Briquetting, for example, compacts the mill scale plus binders into roughly biscuit-sized agglomerates that are relatively well suited to the blast furnace environment But besides being inefficient and expensive compared to the system and methods disclosed herein, such processing for recovery of the iron in mill scale is typically done only with relatively clean scale. Oily and grease-laden mill scales, which have accumulated in large quantities over many decades throughout the world, are not well-suited to such methods because binders do not work well with such materials.

Due to these technical and cost issues, hundreds of millions of tons of mill scale have accumulated in the US alone. The mere cost of placing mill scale in landfills or “dumps” can currently reach seventeen to thirty-five dollars per ton. Other metallurgical waste fines present similar problems. The methods disclosed in the above referenced applications eliminates disposal costs by providing an economical method for recycling fines that does not use binders or sintering processes, avoids dust dispersal, avoids pollution from vaporized hydrocarbons in oily fines, and can use carbon-containing fines in combination with the metallurgical fines to contribute process energy (BTUs) and components for desirable chemical reactions such as oxide reduction. Such applications disclose methods involving the containerization of such materials and adding such materials within the containers to the iron making process.

The above-referenced applications disclose a metallurgical process that involves providing an ingredient enclosure and placing a plurality of granules of a first material in the ingredient enclosure. The first material contains a first ingredient in a metallurgical process. A metallurgical process furnace having a chamber in which ingredients for the metallurgical process are added is provided and the ingredient enclosure and the first material are added to the chamber. The chamber is heated after the addition of the ingredient enclosure and the first material to the chamber, although it may also be heated prior to such addition. In one form, the granules comprise mill scale and the metallurgical process furnace is a blast furnace.

The above referenced applications disclose various concepts and processes related to the thermal processing of materials by various means including containing the materials to be placed in containers, such as capsules, with particular features related to their thermal and mechanical behavior as well as other characteristics. In many cases, these materials are processed, at least partially, while they are in the containers. The described containers can be used in applications involving thermal processing of materials used in carrying out a metallurgical process. Such containers can be used in thermal processing of waste materials and, where appropriate, other applications that do not involve thermal processing or any metallurgical process. While certain examples of such containers or parts of containers formed by the methods disclosed therein (and even herein) may be fully or partially reusable in some processes, there are many situations in which it is appropriate to allow the containers or their components to be consumed during the thermal processing. Particularly in these latter instances, it is desirable to make the containers and any associated processes such as raw materials handling, container forming, container cargo loading, container closure etc. as inexpensive, flexible, and efficient as possible. Herein disclosed are novel concepts, apparatus and methods for achieving one or more of these and other goals.

In the patent applications referenced above, among other concepts disclosed are various types of containers formed with materials capable of withstanding high temperatures including those featuring metallic walls (e.g. steel). In many of the thermal processing uses disclosed in my referenced inventions, the cargo of a container, often a capsule, will itself be of relatively low economic value per unprocessed unit of volume (e.g. mill scales, process dusts, coal fines, recovered scrap, used plastics, tires, waste oils and the like) hence costly methods of fabricating the containers themselves would potentially limit the range of application of the contemplated techniques.

Containers with metal walls such as food, beverage and similar “cans” used for other articles of commerce are known and, with appropriate modifications of such containers in accordance with the teachings of my inventions, could be used for the purposes described in my previous applications and also the present application. These well-known containers are made in so-called two-piece (deep-drawn body plus a separate top) or three-piece form (tubular seamed or drawn body plus separate tops and bottom pieces) configurations. They and the fabrication methods used to create them typically have the following characteristics:
(1) The methods used to produce them are very intolerant of wide feedstock variations.
(2) They are made under very clean debris-free conditions.
(3) They are made by traditional drawing, seam rolling, stamping, impact extrusion methods etc. using close fit male and female hardened steel precision forming dies or other parts which must be frequently maintained against wear.
(4) They must typically be uniform, blemish-free, and well finished to be attractive to the final purchaser.
(5) They must be air and/or liquid leak-tight.
(6) They must not react with their contents over a reasonable shelf life.
(7) They must exhibit a defect rate of the order of 5 rejects per million.
(8) High speed forming of deep forms (e.g. cups/closed-end cylinders) with depth-to-diameter ratios ˜2:1 in steel is problematic—the required high extrusion/stretching forces frequently cause tearing. (NOTE: Aluminum can be drawn into deeper forms but is softer, less strong than steel, and melts at a temperature too low for many of the purposes that containers disclosed herein would be used for.)
(9) Because of the above characteristics and requirements, the requisite tooling (e.g. die sets) are very costly—easily reaching 5 to 6 figure initial cost levels—and must be frequently replaced or repaired.

In contrast to the characteristics enumerated above for traditional metal container forming methods, disclosed herein are novel apparatus and methods of producing container components that will be referred to as the Wrinkle Forming Process (WFP). Forms, such as the container components, with depths equal to or greater than diameters (or widths) can be readily achieved using the WFP.

In presently-used traditional drawing processes, “hold down plates” (HDP) must be used to apply very substantial and uniform forces to keep stock blanks flat as they are being drawn between close-fitting male and female dies. As draws get deeper and approach 2:1, very precise empirical control of these forces must be achieved to avoid wrinkles without tearing the stock. Such process can be relatively expensive, especially depending on what the containers are being used for.

Therefore a need exists for improved containers and container components and a method and apparatus for forming such containers.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 shows a side view one form of apparatus for forming a container;

FIG. 2 shows a top view of the apparatus for forming a container of FIG. 1;

FIG. 3 shows a top view of one form of a pre-formed blank that can be used with the apparatus of FIG. 1;

FIG. 4 shows one form of filling the container components made by the apparatus of FIG. 1;

FIG. 5 shows one form of a pre-perforated sheet stock where the used of an apparatus, similar to that shown in FIG. 1, induces separation of the formed container component;

FIG. 6 shows the exterior surface of one form of a container component formed by the apparatus of FIG. 1;

FIG. 7 shows interior surface of another form of a container component formed by the apparatus of FIG. 1;

FIG. 8 shows the exterior surface of the container component of FIG. 7;

FIG. 9 shows a portion of an alternate apparatus for forming a container, including several fully formed containers and several container components.

### DETAILED DESCRIPTION

In contrast to the traditional drawing process referenced above, the Wrinkle Forming Process often forms wrinkles.

Wrinkle Forming Apparatus 20 is a device that is used to form containers, such as enclosures 48 and 50 and/or container components 26. In one form, a Wrinkle Height Limit (WHL) Plate 22 and Aperture Plate 24 are used in the WFP and apply very little overall pressure to stock and expressly allow wrinkles to form. Compared to traditional metal container fabrication techniques, the Wrinkle Forming Process has almost diametrically opposite constraints and requirements and correspondingly offers the following advantageous features:
(1a) WFP can produce metallic containers and other forms at high speeds using inexpensive machinery that is very tolerant of the presence of debris and wide variation in sheet stock shape, gauge, temper etc.
(2a) WFP can operate in very dirty and gritty environments.
(3a) No close tolerances need be involved or held.
(4a) WFP need NOT produce perfectly shaped and highly finished product because it is primarily intended to create CONSUMABLE containers with appropriate mechanical and thermal properties but no stringent aesthetic uniformity requirement. Blemish-free starting material is NOT required.
(5a) As formed, containers made with WFP components alone will often not be perfectly leak-tight. In their many areas of application of such components, leak-tight is NOT a requirement. However, additional optional elements such as coatings, sealants, gaskets and/or seamed joints can be employed to make the resulting container leak-tight. Also liquid, gas, and/or vapor barriers can be placed inside containers or on the joining elements (e.g. flanges) of WFP formed parts to provide such performance over a useful or initial range of temperatures.
(6a) In one of their primary fields of use, no significant shelf-life issues should be encountered because required container life will typically be measured in hours to weeks or months at most and the container content will generally be inert under normal storage conditions.
(7a) Because of the forgiving nature of the WFP, very low reject rates should be readily achieved.
(8a) WFP can easily create sheet steel forms (container components) much deeper than a depth to diameter (or width) ratio of 2:1. Furthermore, the produced forms can produce intentionally complex surface features and be axially asymmetric. Importantly, the WFP relies on neither significant extrusion nor stretching of the sheet stock blank; instead it creates the form almost entirely through wrinkling, buckling, and bending. Such deformations require very low forces to be applied to the blanks. As will be described later, features can be included in the WFP tooling (e.g. surface features on the Wrinkle Height Limiter (WHL—see FIG. 1 below) and/or in blank pre-forming preparation (slits etc) that can serve to nucleate or suppress particular wrinkling patterns. Additionally, the Deformation Former 28 can have a patterned surface that is designed to guide the formation of wrinkles in certain areas.
(9a) WFP tooling does not require a high degree of surface finish, can be made of mild unhardened steel, and can operate without the need to maintain precise alignments of mating parts. In many instances, clearances can be ⅛ inch or more without becoming critical to or impairing the usability of the finished form. Variations in blank dimensions and gauge are similarly well-tolerated.

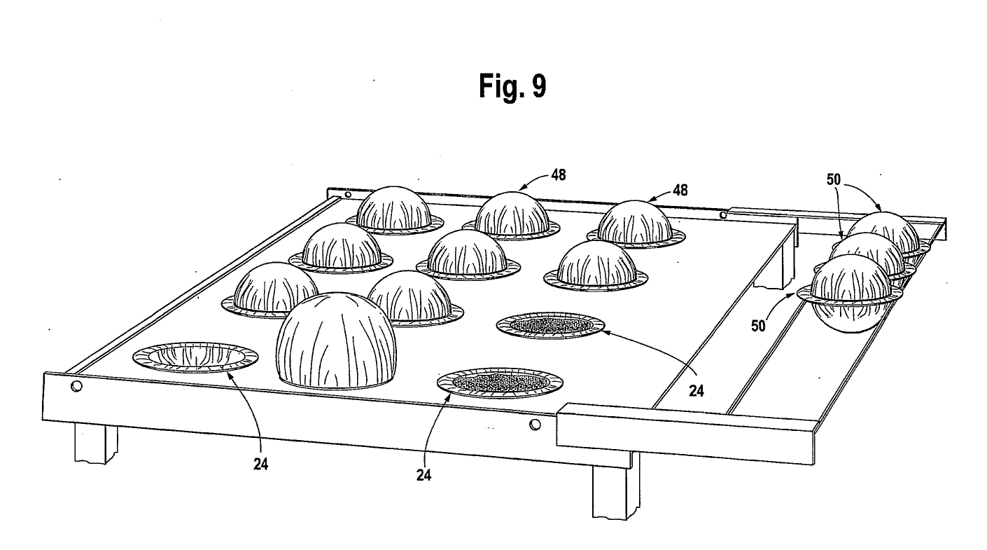

FIG. 1 shows a schematic representation of the basics of a WFP apparatus 20 suited to the manufacture of many types of forms, such as somewhat hemi-spherical shaped container component 26. The forming of flanged hemispheres 26 is illustrated here only as an example. Approximately spherical containers (see FIG. 9) can be made by joining a pair of these hemispherical forms 26 to basically form a complete sphere. Serviceable containers for some applications can be made by using a flat piece of sheet stock to close single hemispheres after loading with cargo. However, spherical containers are the most efficient of all forms re amount of wall material required vs. contained volume of container cargo.

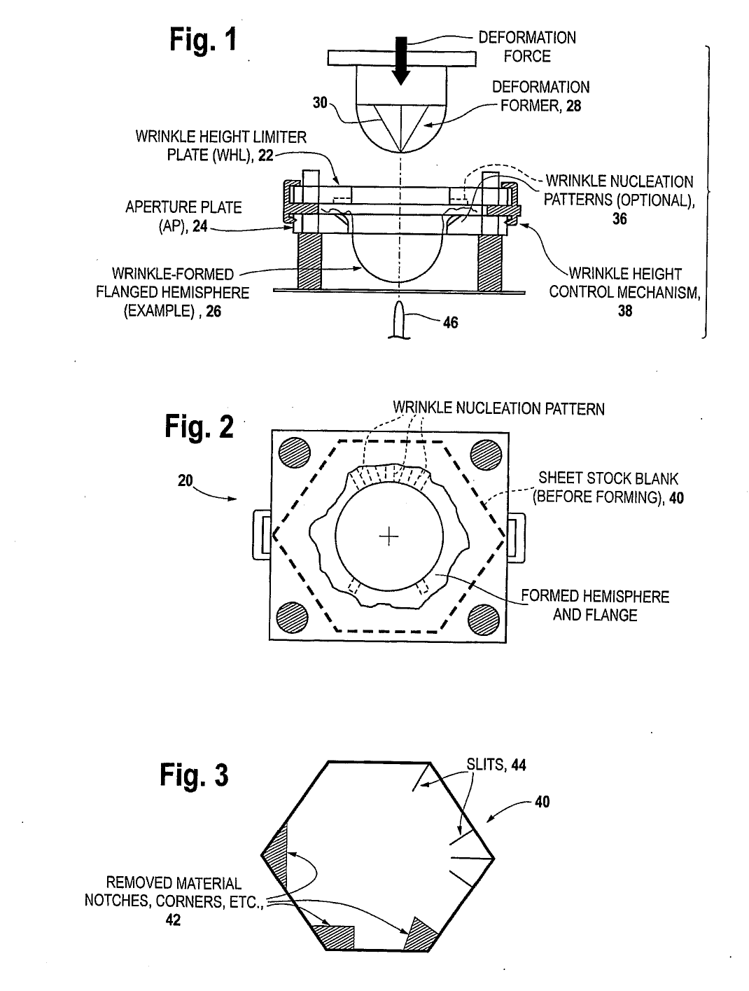

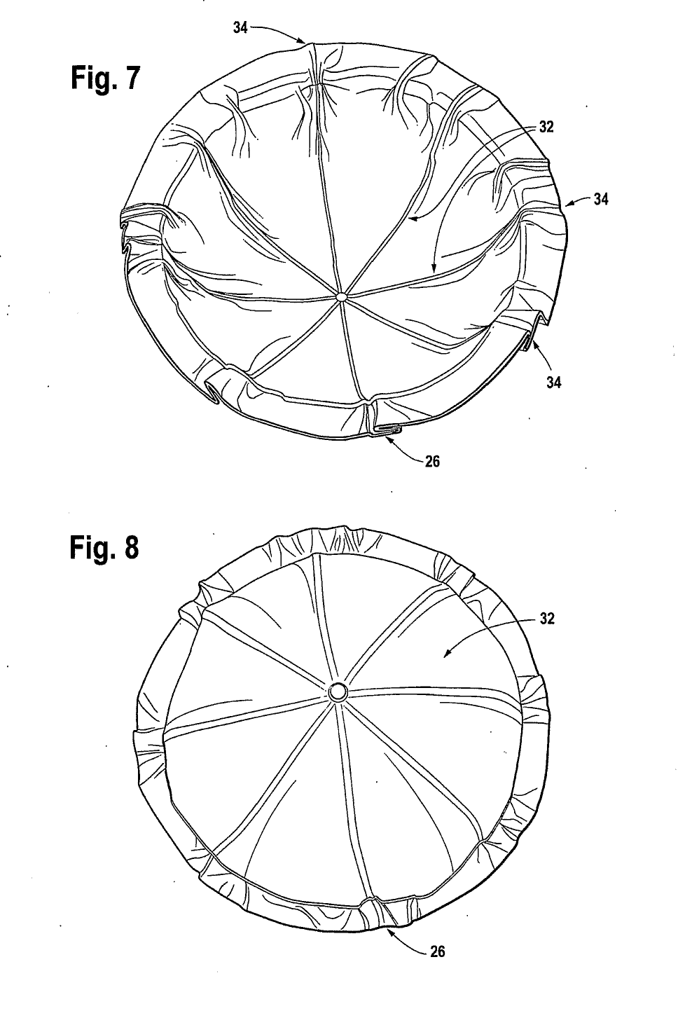

The Deformation Former 28 defines the basic shape of the resulting part 26. It need only exert and withstand deformation forces sufficient to bend and wrinkle the essentially unsupported and loosely constrained product blank (see 40 in FIGS. 2, 3 and 5). The Deformation Former 28 can have a simple circular cross-section as illustrated or can be more complex with cross-sections that are combinations of various basic shapes. The Deformation Former 28 can be axially fluted or otherwise be of different cross-sections along its length. Since the forming forces involved in the WFP 20 are relatively small, the Deformation Former 28 may readily be made of an assembly of sub-parts that are supported in place during forming by internally applied forces (e.g. hydraulic) or mechanical constraints such as fitted parts. In such cases, the Former 28 can be disassembled in place after the forming stroke is complete and extracted in pieces. The Former 28 can also be designed to change its shape part-way through its stroke by, for example, extending or withdrawing a sub-former element, such as a somewhat star shaped element 30 that is used to promote wrinkle occurring in specific places in the form 26 (see forms 26 of FIGS. 7 and 8 and the star-shaped pattern 32 therein that promotes wrinkles 34 forming in specific places in form 26).

The apertures in the WHL 22 and Aperture Plate (AP) 24, both of which should be sufficiently thick to resist the forces applied to the Former without significantly large deflections, approximately match the maximum cross-section of the Former 28 with all-around clearances well in excess of the thickness of the unformed product blanks. The WHL 22 can be flat or patterned on its lower surface with small variations of thickness in a wrinkle nucleation pattern 36. This patterning (exaggerated for clarity in FIG. 1) can nucleate the formation of areas of controlled and therefore repeatable wrinkling of the sheet. The aperture in the AP 24 can be designed with a radius around its perimeter (as shown) to facilitate travel of the product sheet as it deforms and wrinkles into the desired final shape. In addition, the upper surface of the AP 24 can incorporate wrinkle nucleating patterns 36 (instead of or in addition to those on the WHL 22) that invite controlled wrinkling (e.g. grooves extending out radially the AP 24) especially in the vicinity of flanged regions.

The Wrinkle Height Control Mechanism 38 can be as simple as passive spacers and fasteners or equivalent devices that fix the maximum separation of the WHL 22 and the AP 24 and can be adjustable by adding or removing spacers, etc. The spacer 38 mechanism can be designed to allow reduction of the maximum allowable height as the last stages of forming occur. This can encourage the formation of flange regions that are substantially flatter than would otherwise be the case. The wrinkle height control spacing 38 may also be varied dynamically during any other portions of the forming cycle to enhance or reduce the effect, for example, of any of the plate features described above or the shape and other features of the blanks themselves. For example, the WHL 22 plate could be hydraulically pushed down toward the end of the forming and the spacing system could allow for this downward movement

FIG. 2 shows a schematic top view of the apparatus 20. The blank 40 shown is hexagonal and results in minimal scrap but the starting shape is not very critical, for example, circular blanks can be used. If scrap material is generated in making the blank forms for processing that involves recovery of, say, ferrous content from mill scale, any excess scrap (i.e. steel) can merely be included in the container cargo itself and the iron units therein fully recovered.

An inherently useful characteristic of containers made by the WFP method is that the wrinkles 34 in the containers impart some expansion, stress-relief and graceful yield capabilities to the container walls if/when they are subjected to high impact forces including those potentially encountered by containers to be used in Mill Scale recovery via injection into Blast Furnaces or other hot iron/steel metal producing processes.

FIG. 3 shows some additional features that can be used to advantage in using WFP techniques. These are illustrated on hexagonal blanks but can apply to other starting shapes. Notches 42 and slits 44 in flat stock blanks 40 can be used to cause the WFP to create controlled overlapping conforming wall regions in the resulting object rather than regions comprised of many small or collapsed wrinkles per se.

Long cuts 44 in the blanks can be used advantageously to form axially-oriented overlaps when making deep forms 26. Forming overlaps associated with slits or notches can be facilitated by introducing small bends in the axial direction on opposite sides of the slit or notch. Such bends can be easily created by the slitting or notching mechanism or by small height variations (patterns) on the WHL 22 and/or AP 24 (or possible the Deformation Former) surfaces as discussed earlier. These strategies are optional and generally not necessarily required for hemispherical or similar aspect ratio forms.

Re-entrant WFP objects can be made by the methods disclosed here by arranging for the primary Deformation Former 28 to have an open cavity of the desired shape at its bottom end which mates loosely with a complementary Secondary Former 46 extending upward from below and toward the Aperture Plate in the apparatus shown in FIG. 1. In one form, Secondary Former 46 is raised during at least part of the formation process as primary Deformation Former 28 is lowered. In another form, Secondary Former 46 remains stationary and is contacted by form 26 as it is deformed by the primary Deformation Former 28. In any event, the resulting form 26 has a greater surface area which can be beneficial in certain applications involving heat treatment of the material that will be place in form 26.

In certain circumstances, for example with thick stock, it can be desirable to soften the blanks 40 by pre-heating them and providing heating means for the Deformation Former 28 (and/or 46), WHL plate 22 and/or AP 24 or any combination thereof. The Former 28 (and 46) and other parts, as necessary, can be made of oxidation-resistant high temperature materials. The entire WFP 20 mechanism can be operated in, e.g., a nitrogen atmosphere.

Vibratory forces, sonic or ultrasonic excitation can be applied to the Deformation Former (28 and/or 46), the WHL 22, and/or the AP 24 to reduce frictional drag forces between stock and plates during forming.

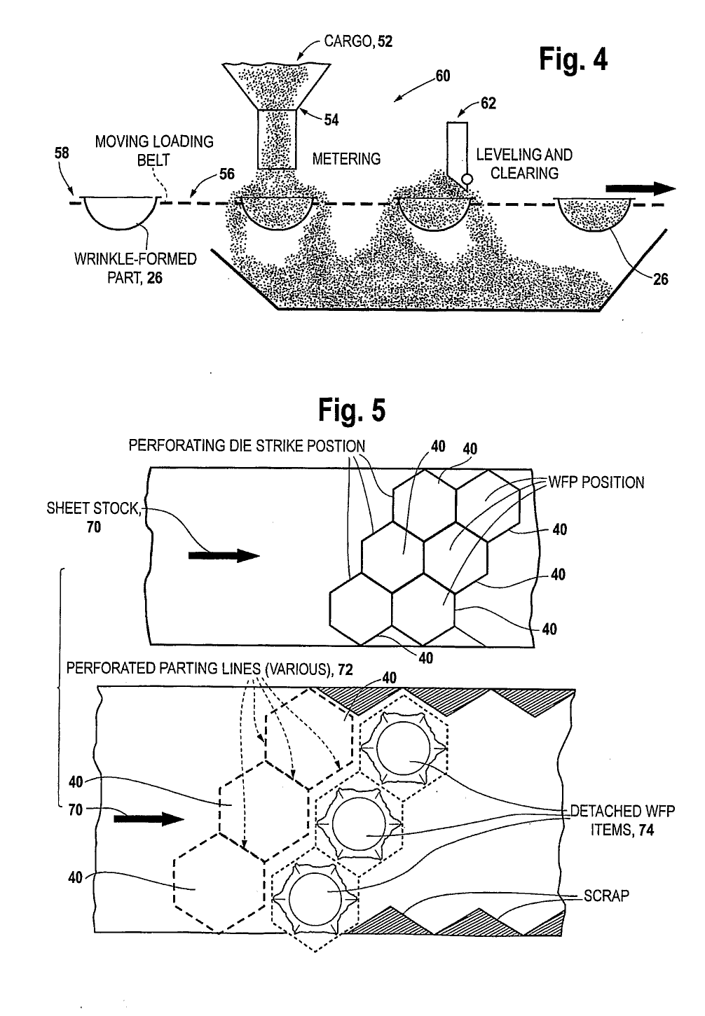

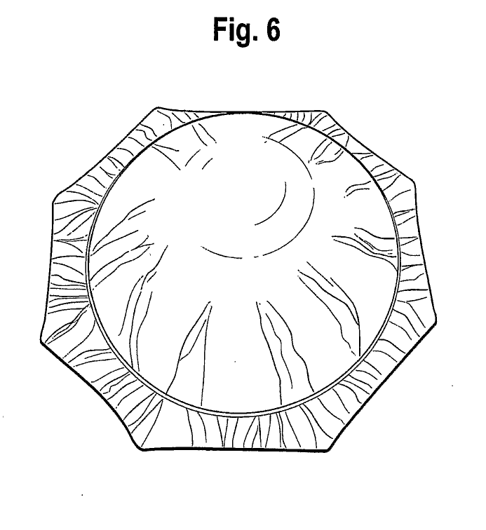

Creation of complete containers, such as capsules 48 and 50, containing cargoes to be processed typically involves both a filling step followed by some kind of assembly/closure operation. One useful method of rapid hemisphere-filling of the container component forms 26 is shown schematically in FIG. 4. Note that bulk cargo (e.g. mill scales, process dusts, coal fines, recovered scrap, used plastics, tires, waste oils and the like), can be imprecisely metered through chute 54 and piled on the loading system 60 and into the formed container components 26. Excess material passes through the screen 56 or grid-like transport belt, such as a conveyor belt 58 directly or because of a suitable content leveling device 62 acting upon the open container components to scrape off excess material and level the cargo in the container component 26. Any such material is simply returned to stock by any suitable means to be loaded again. This same technique can be used with non-moving but porous positioners (e,g open grid-topped tables) for the containers to be filled.

After cargo is loaded, the hemispheres must be closed to a sufficient degree to retain the content. As pointed out in my earlier referenced disclosures, sintering and internal friction in the cargo allows gritty materials, such as mill scale for example, to be well retained while gases and vapors can escape the containers through small openings and/or thermally enlarged vents. Container assembly and closing operations can comprise, but are not limited to one or more of the following: stapling, riveting, folding, crimping, rolling, spot-welding, seaming, and in some situations, soldering or adhesive melts etc.

For example, in the case of the hemisphere example illustrated above, the maker might choose to form a full approximately spherical container 50 by spot-welding the WFP formed flanges of a pair of filled hemispheres together. Flange wrinkles can be further flattened, if necessary, before or during spot-welding, stapling, riveting etc. to insure adequate flatness. The content of the hemispheres (before joining) can be retained by temporary cover sheets (such cover sheets can be consumable and affixed by hot glue or other adhesives), moveable gates, magnetic forces (in the case of ferrous cargo) or by many other coverings.

In general, the Wrinkle Forming Process is adaptable to a wide range of sizes—e.g. hemispheres from much less than 5″ to greater than 12″-15″ diameter can be easily and inexpensively made. For example, a 7 inch diameter flanged hemisphere 3.5 inches deep can be hand-formed from un-annealed 0.012″ Cold Rolled sheet steel in a few seconds using very simple tooling and the force generated manually with an ordinary machine shop arbor press (total applied force is estimated less than one ton). One advantage over prior methods, is that the Wrinkle Forming Process uses lower pressure and thus the blanks do not need to be held, or can be held using less force and less precisely than previous methods and no die is needed on the opposite side of the blank from the deformation former 28.

FIG. 1 allows for a final downward movement of the WHL plate 22 to further flatten the already height-limited wrinkles 34 on the flanges but this can be accomplished in a variety of ways. For example, merely by using retaining pins holding the WHL plate 22 that do not allow it to move up more than the desired maximum wrinkle height, but do allow it to move down as the Deformation Former 28 finishes its stroke thus applying downward pressure to the WHL plate 28. This is only one example of the use of a WHL spacing that can be controlled and made variable as forming proceeds using at least a portion of the Wrinkle Height Control Mechanism.

Given the low forces required, single machines (a portion being shown in FIG. 9) equipped with arrays of multiple (say 2 to 9) apertures in aperture plate 24 simultaneously activated Deformation Formers 28 can be readily designed for large quantity production and would require only small fast-cycling (10 to 60 ton) hydraulic or screw-driven presses. Importantly, these presses are low-cost and have small footprints. Together with CR coil stock handlers, sheet straighteners plus automated shearing and positioning stations they could form an efficient, compact and agile on-site container fabrication system for e.g. Mill Scale processing.

The well-known art of progressive and/or multiple-acting die design can be applied when using WFP 20. A key difference is that no close mating expensive die parts are needed with the possible exception of the die that does the blank cutting step. This die could typically be a simple circle or hexagon cutter in the case of forming hemispheres. Since in some instances, burrs on the pre-form blanks can be tolerated by the WFP method (which would simply compress many of the standing burrs) thus even this cutting die can be of relatively low precision.

Referring to FIG. 5, WFP forming can be accomplished using a continuous feed of blank stock 70 in the form of an intermittently advanced strip, a parting line 72 (“tear-here”) die step can precede the WFP step. This can comprise a die producing weakened regions such as a series of closely spaced but not quite continuous perforations 72 at the boundary or perimeter of the desired effective shape of the blank 40. As the Deformation Former 28 subsequently performs its forming step on a given blank, the next blanks in line for forming (or material outside of desired boundary of the blanks being processed) can be momentarily simply clamped to allow the small WFP deforming forces to separate the forming objects 74 from adjacent blank stock 40 so the forming can continue uninfluenced by the detached material. Strip sheet can be perforated in near-zero scrap hex patterns and formed in multiples this way as shown schematically in FIG. 5. Note that, in contrast to traditional drawing used in progressive dies, the WFP 20 inherently applies the necessary lateral forces to do the required separations.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A process for forming a container, the process comprising:
providing a deformable blank over an aperture;
providing a first deformation former on the opposite of the blank from the aperture;
moving the first deformation former in a direction toward the blank and the aperture;
applying a force to the blank using the first deformation former;
deforming the blank through the aperture using the deformation former.

2. The process of claim 1 further comprising;
providing a second deformation former on the opposite side of the aperture from the first deformation former;
contacting the blank with the second deformation former as it is being deformed through the aperture;
deforming a portion of the blank with the second deformation former.

3. The process of claim 1 further comprising;
wrinkling the blank as the blank is deformed.

4. The process of claim 3 further comprising;
providing a wrinkle height limiter to control the height of the wrinkling along the edges of the blank.

4. The process of claim 3 further comprising;
controlling the areas of wrinkling as the blank is deformed.

5. An apparatus for forming a container, the apparatus comprising:
an aperture;
a first deformation former designed to loosely mate with the aperture;
wherein the first deformation former is movable toward and at least part way through the aperture and applies a force to a blank thereby deforming the blank through the aperture.
